(19) United States
(12) Patent Application Publication
(10) Pub. No.: US 2011/0133494 A1
(43) Pub. Date: Jun. 9, 2011

(54) Door lock tool

(76) Inventors: Edward Cameron Nind Hopkins, Henderson, NV (US); William H. Rogers, St. Augustine, FL (US); Matthew E. McKendrick, Jacksonville, FL (US)

(21) Appl. No.: 12/592,943

(22) Filed: Dec. 4, 2009

(51) Int. Cl. E05C 19/00

(52) U.S. Cl. 292/253

(57) ABSTRACT

The door lock tool is used for securing closed swinging “push” doors against opening under the application of physical force and includes a hook and a length of braided nylon webbing. The hooks is designed to bite into the sides of the door jams and casings and has a generally J-shaped body which includes a flat back part that curves into a relatively short perpendicular leg part. A flat tooth extends perpendicularly from the hook's leg. One end of the strap is configured to form a loop for securing the strap to a door knob. The other end is laced through an opening in the hook and around a cross bar, which allows the strap to be pulled tight. Pulling the free end of the strap tightens the strap to close the loop and shortens the length of strap between the loop and the hook causing the hook to bite into or under the end of the door jam or casing to secure the door.

This invention relates to tools for securing a closed door, and in particular a security tool for holding a door closed in emergency applications.

### BACKGROUND AND SUMMARY OF THE INVENTION

Hinged doors can often be breached by an application of physical force directly to the door adjacent the door knob and lock mechanisms. A strong kick can deform the door or door frame enough to defeat the door's locking mechanism or cause damage to the door frame to such a degree that the mechanism is destroyed or fails.

Heretofore, a variety of reinforcing security prop bars have been developed to prevent hinged doors from being breached by the application of force. These prop bars simply abut against the doors to hold them closed. Much like a simple door wedge, security prop bars depend on the holding force of the prop or bar against the floor behind the door. Many security prop bars use special brackets permanently secured to the floor. Others rely on friction to provide their holding force. While conventional security prop bars are generally effective at preventing hinged doors, which open inward toward the occupant's side of the doorway, from being breached by physical force, they have several practical drawbacks. First, the door must swing inward toward the occupant; if it swings outward away from the occupant, a barricading wedge or bar cannot function because the opening motion is away from the barricading device. Second, mounting brackets to the floor is often impractical and undesirable. Conveniently storing the prop bars for rapid deployment can be an issue in many applications. Most of all, the time it takes to retrieve and deployment of the heavy prop bars from their storage location under the stress of an emergency situation can make their use impractical.

The present invention provides a tool for securing a closed swinging “push” door against opening away from the occupant under the application of physical force. The door lock tool includes a hook and a length of braided nylon webbing, which is adjustably connected to the hook. The hook has a generally J-shaped body which includes a flat back part that curves into a relatively short perpendicular leg part. A flat tooth extends perpendicularly from the hook's leg. One end of the strap is configured to form a loop for securing the strap to a door knob. The other end is laced through an opening in the hook and around a cross bar so that pulling the free end of the strap tightens the strap to close the loop and shorten the length of strap between the loop and the hook.

The door lock tool is used to secure a closed outward swing “push” door by initially placing the looped end of the strap around the door knob. Once the loop is wrapped around the door knob, the hook is positioned to catch the end of the door jam or door casing and the free end of the strap is pulled tight. As the strap is pulled tight to shorten the length of strap between the loop and the hook, the tooth bites into or under the end of the door jam or casing to secure the door. With the door lock tool so fitted to a closed outward swinging “push” door, the door cannot be forced open from either side. The outward force caused by physically pulling on the door on the other side of the secured door is retarded by the tensile strength of the braided nylon web and perpendicular holding force created by the engagement between the hook and the door jam.

The door lock tool embodying this invention can be reliably used to secure a swinging “push” door closed and prevent it from being forceably opened. The door lock tool is compact for convenient storage. The hook and strap configuration makes the tool simple and fast to employ and can be used on any door that has a conventional door knob.

Other advantages will become apparent upon a reading of the following description.

### BRIEF DESCRIPTION OF THE DRAWINGS

The preferred embodiments of the invention have been depicted for illustrative purposes only wherein:

FIG. 1 is a perspective view of an embodiment of the door lock tool of this invention showing a portion of the strap cut away;

FIG. 2 is another perspective view of the door lock tool of FIG. 1;

FIG. 3 is a third perspective view of the door lock tool of FIG. 1 showing a portion of the hook cut away;

FIG. 4 is a perspective view of the door lock tool of FIG. 1 showing the initial attitude of the tool for securing a closed swinging “push” door;

FIG. 5 is a perspective view of the door lock tool of FIG. 1 showing the looped enc of the strap wrapped around the door knob;

FIG. 6 is a perspective view of the door lock tool of FIG. 1 showing the hook biting into the door frame and the free end of the strap tightening;

FIG. 7 is a perspective view of the door lock tool of FIG. 1 showing the free end of the strap wrapped around the door knob; and

FIG. 8 is a simplified top view of the door lock tool of FIG. 1 showing the free end of the strap being tightened around the door knob securing a closed swinging “push” door.

### DESCRIPTION OF THE PREFERRED EMBODIMENTS

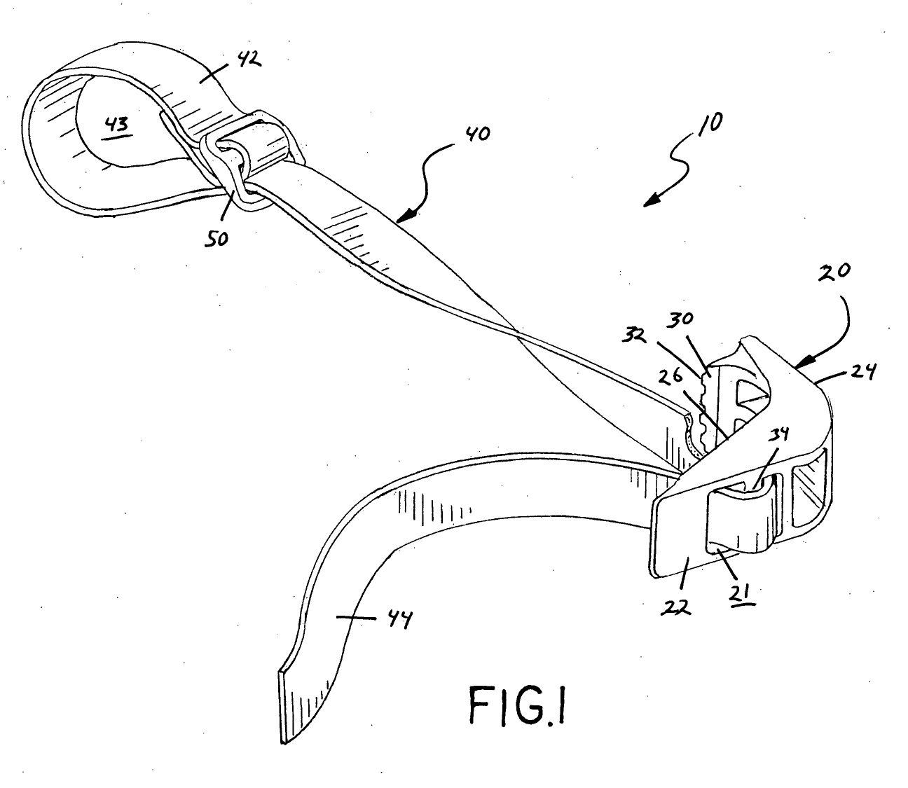

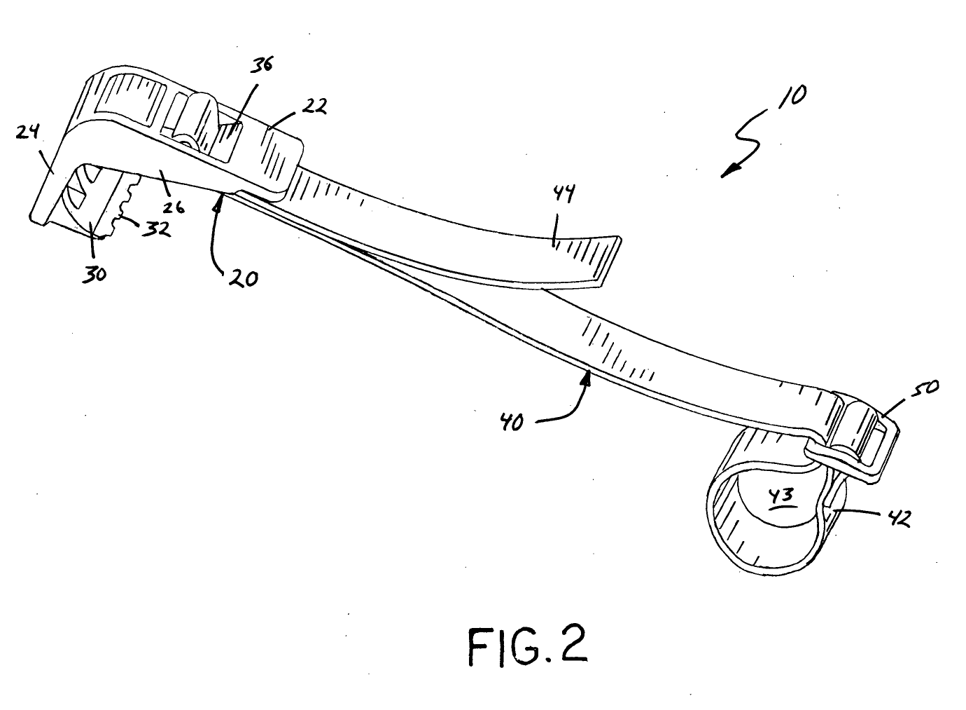

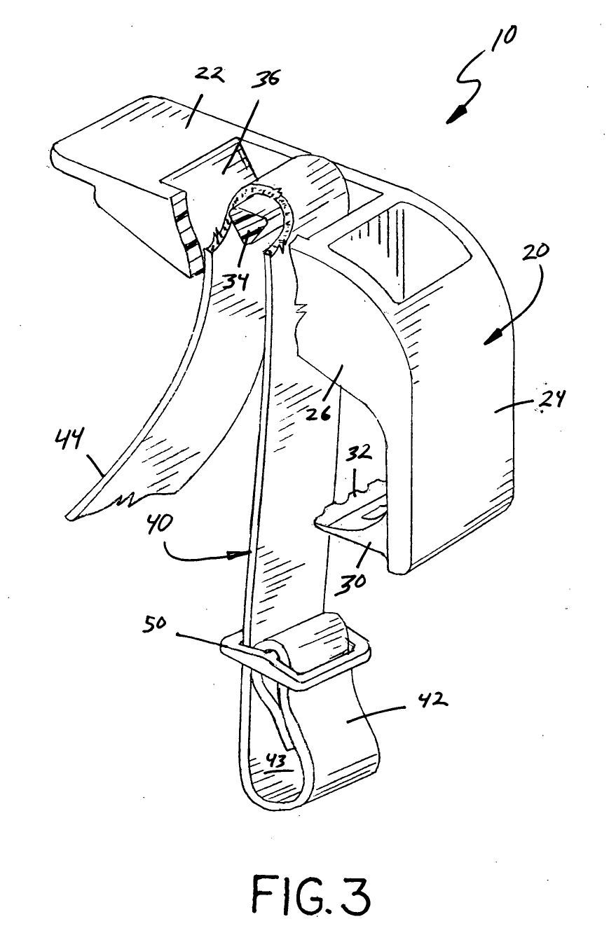

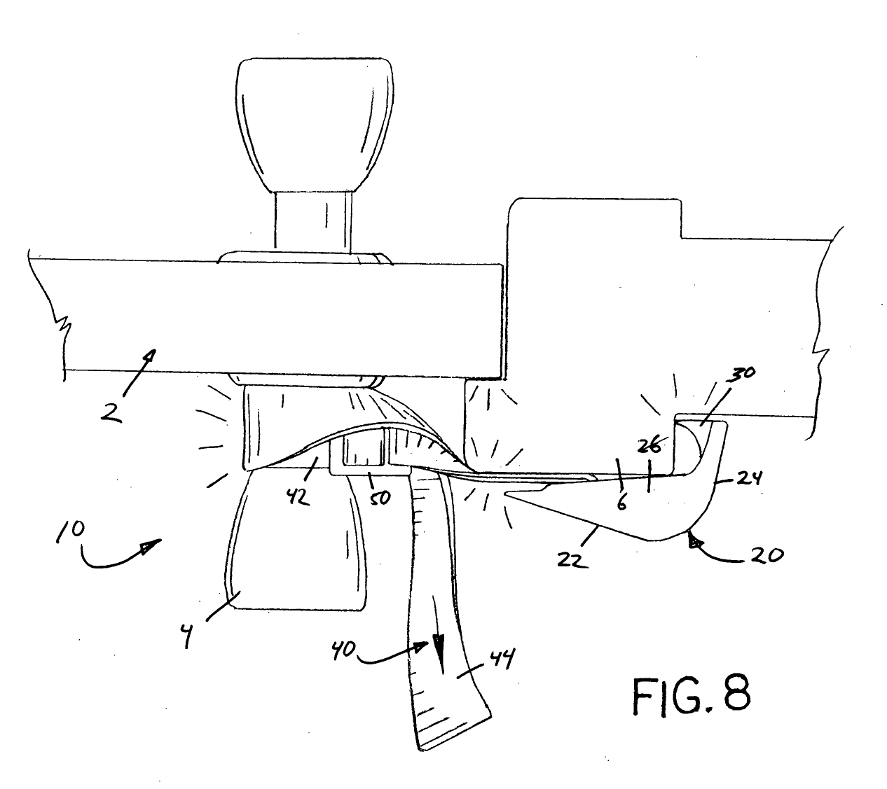

Referring now to the drawings, FIGS. 1-8 show an embodiment of the door lock tool of this invention, which is designated generally as reference number 10. Door lock tool 10 includes a hook 20 and a length of webbing or strap 40 adjustably connected to the hook. Ideally, hook 20 is formed or molded from a polymer plastic, such as glass filled Nylon, although other suitable plastics or metals can be used. Hook 20 has a generally J-shaped body, which includes a flat back part 22 that curves into a relatively short perpendicular leg part 24. Hook 20 also includes triangular sides 26 which provide a reinforcing web between back 22 and leg 24. A flat tooth 30 extends from the hook leg 24, which as shown, is generally parallel and spaced from hook back 22. Tooth 30 has a series of reinforcing serrations 32 along its outer face. Hook 20 has an opening 21 formed in along hook back 22 through which strap 40 is adjustably secured. A cross bar 34 extends through opening 21. As best shown in FIG. 3, hook 20 also has an inclined surface 36, which faces opening 21 and terminates in a contact edge 38. Cross bar 34 is parallel to and spaced from contact edge 38 and both are transverse to the length of the strap 40. The parallel arrangement of cross bar 34 and contact edge 38 presents the structure for adjustably securing the strap 40 to the hook and is commonly used in strap buckles, ladder slides and the like and therefore need not be described in detail. The proximal end of hook 20 acts as a release lever for loosening strap 30. Strap 30 is a length of flat braided nylon webbing. A tri-glide 50 is secured to one end of strap 40, which is referred to hereinafter as “looped end” 42. Looped end 42 of strap 40 is laced through tri-glide 50 so as to form a loop 43 in the strap. The opposite end of strap 30, which is referred to hereinafter as “free end” 44 is laced through opening 21 around cross bar 34 so that pulling the free end 44 tightens strap 40 closing loop 43 and shortening the length of strap between the loop and hook 20.

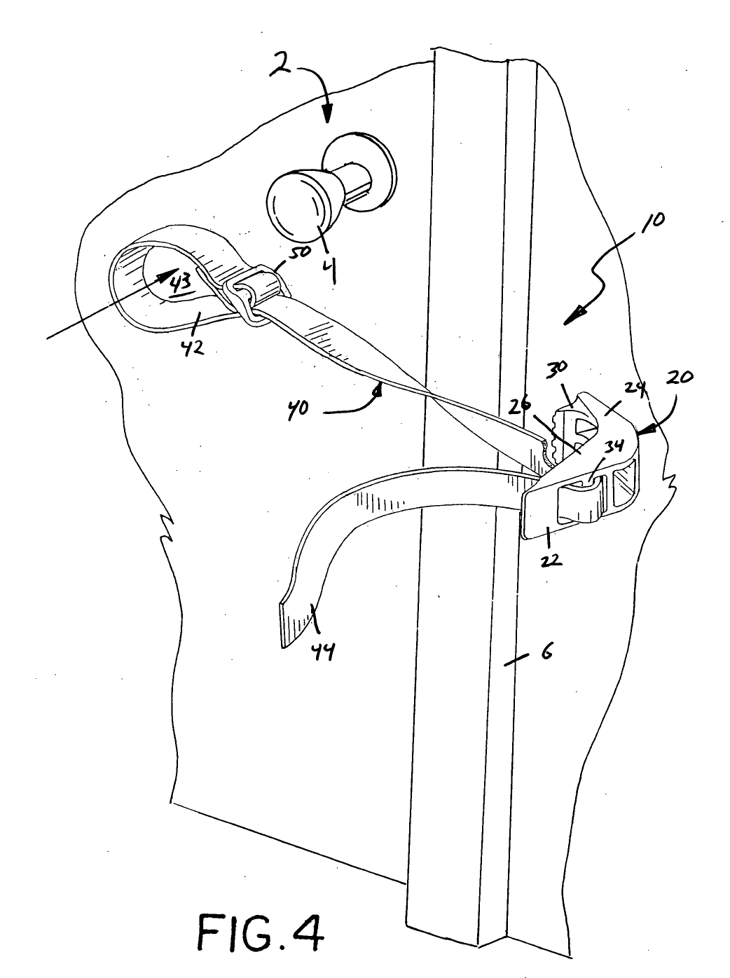

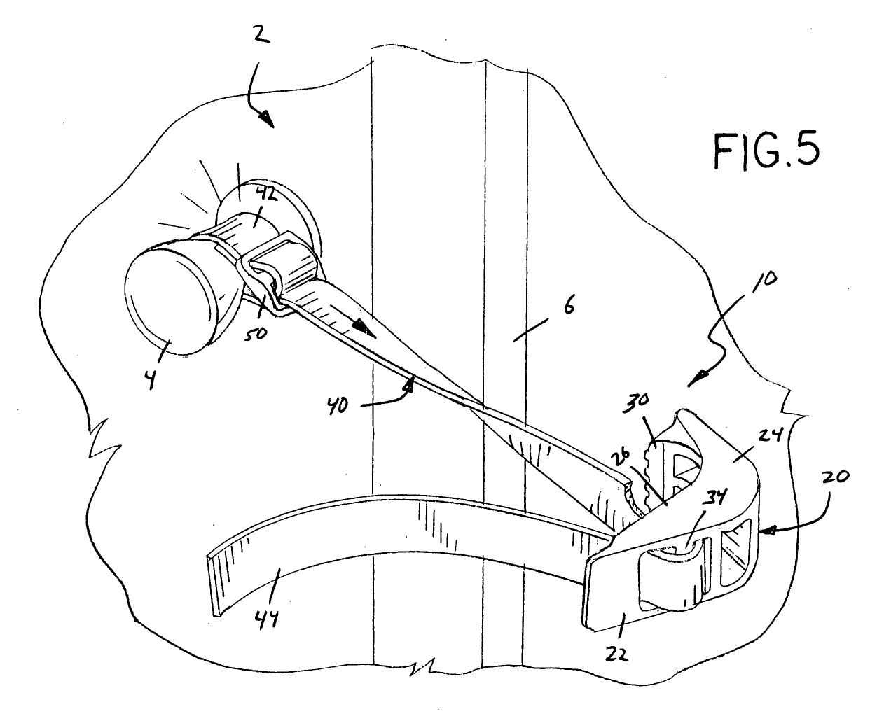

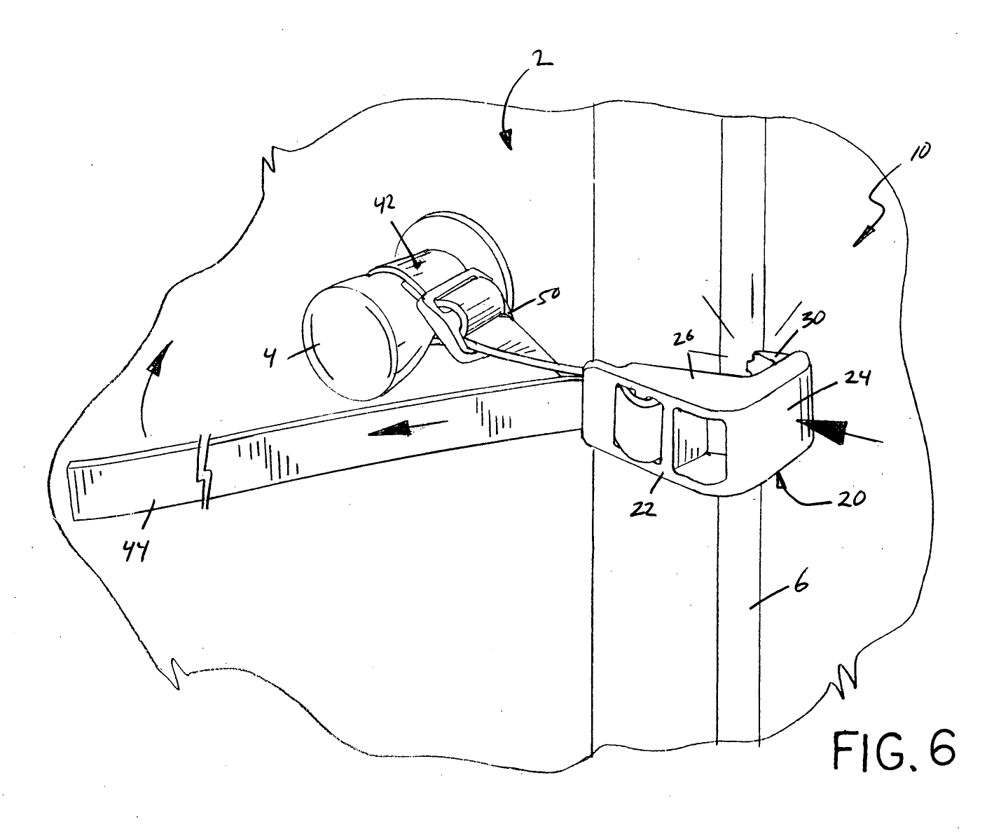

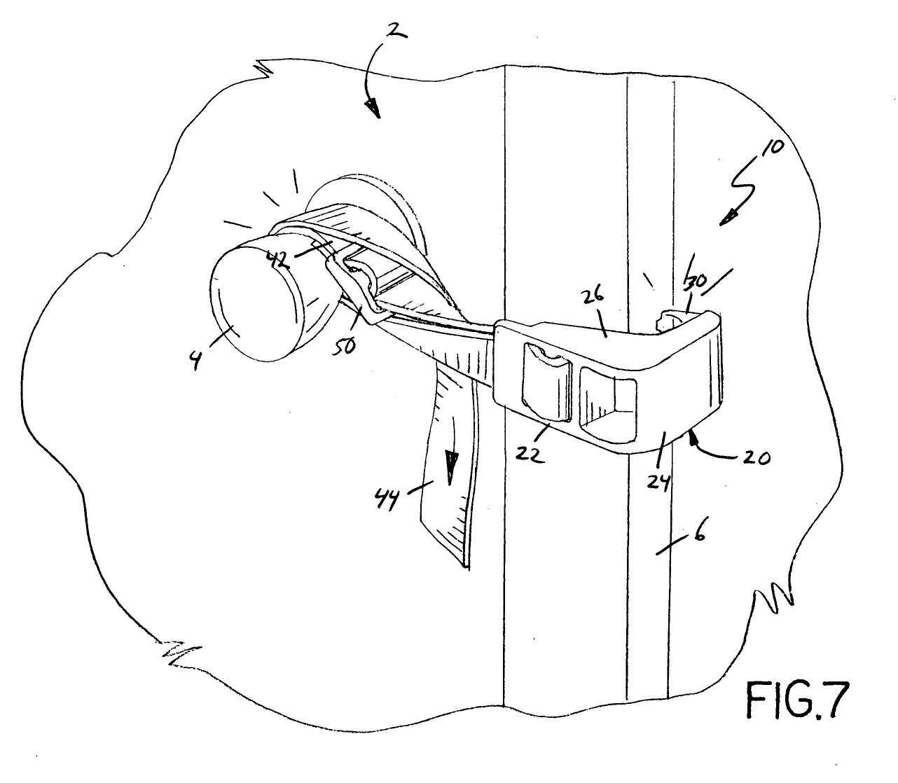

FIGS. 4-8 illustrate the use of door lock tool 10 for securing a closed swinging “push” door 2. As shown in FIGS. 4 and 5, initially loop 43 of strap 40 is placed around door knob 4 of a outward swinging hinged door 2 and tightened. Loop 43 is tightened around door knob 4 simply by pulling on free end 44 of strap 40. Once loop 43 is secured around door knob 4, hook 20 is positioned to catch the end or edge of casing or door jam 6. As shown in FIG. 6, with hook 20 positioned to catch the end of door jam 6, the free end 44 of strap 40 is again pulled tight to shorten the length of strap 40 between the loop 43 and hook 20. As strap 40 is pulled tight, tooth 30 bites into or under the end of door jam 6. Ideally, hook 20 is positioned adjacent door knob 4 so that strap 40 runs horizontally between hook 20 and door knob 4. As shown in FIGS. 6-7, once strap 40 is pulled tight and the length of strap 40 is as short as possible, free end 4 of strap 40 is wrapped back around door knob 4 and tucked around the middle portion of strap 40 between loop 43 and hook 20. As shown in FIG. 9, with door lock tool 10 fitted to a closed door, the door cannot be forced open. When strap 40 is drawn tight, the edges of hook sides 26 abut flat against the outer face of the door jam 6 and strap 40 lies flat between the door ram and hook back 22. It should be noted that the distance between the longitudinal plane of the back 22 of hook 30 and the longitudinal plane of tooth 30 is selected to accommodate the thickness of most conventional door jams and casings. As such, the edges of hook sides 26 to lie in abutment against the front of door jam 6 and the tooth 30 bites into or underneath door jam 6. Pulling door 2 open is prevented by shorted strap 40 and hook 20, which are securely clasped to door jam 6. The outward force caused by physically pulling door 2 is retarded by the tensile strength of the braided nylon web and the perpendicular holding force created by the engagement between hook 20 and the fixed door jam 6.

One skilled in the art will note several advantages of this invention over conventional door prop bars. The door lock tool embodying this invention can be reliably used to secure a closed swinging “push” door and prevent it from being forceably opened. The door lock tool is compact for convenient storage. The hook and strap configuration makes the tool simple and fast to employ and can be used on any swinging “push” door having a conventional door knob. Because of its compact size and the convenience of its use, the door lock tool of this invention is ideally suited for emergency applications, such as home invasion or active shooter situations, where the tool can be used to physically secure an outward swinging “push” door from opening.

The preferred embodiment herein described is not intended to be exhaustive or to limit the invention to the precise form disclosed. It is chosen and described to explain the invention so that others skilled in the art might utilize its teachings. It is understood that the above description does not limit the invention to the details given, but may be modified within the scope of the following claims.

I claim:

1. A door lock tool for securing a swinging door closed wherein the swinging door includes a door knob and is hinged to a door jam, the door lock tool comprising:
a hook adapted for clasping the door jam; and a strap,
the strap having a first end and a second end thereof, the first end configured to form a loop thereof for restrictively receiving the door knob of a closed door, the second strap end adjustably connected to the hook such that pulling the second strap end tightens the strap loop around the door knob and shortens the length of the strap between the strap loop and the hook.

2. The door lock tool of claim 1 wherein the hook has a J-shaped body and includes a back part, a leg extending from the back part, and a tooth part extending from the leg part, the tooth part is spaced parallel from the back part and adapted to contact the door jam.

3. The door lock tool of claim 2 wherein the tooth part has a plurality of serrations formed on one face thereof.

4. The door lock tool of claim 2 wherein the hook has an opening defined therein through which the strap is laced.

5. The door lock tool of claim 4 wherein the hook also includes a cross bar traversing the opening in the hook and an inclined surface adjacent to and facing the opening therein and terminating in a edge spaced from and parallel to the cross bar, the strap extending through the opening and being wrapped around the cross bar, the strap engaging the edge of the inclined surface to secure the strap to the hook and spaced from the edge of the inclined surface to permit adjustment of the strap relative to the hook.
